(19) United States
(12) Patent Application Publication
(10) Pub. No.: US 2023/0004152 A1
(43) Pub. Date: Jan. 5, 2023

(54) METHOD FOR MONITORING AND/OR PREDECTING MACHINING PROCESSES AND/OR MACHNINING OUTCOMES

(71) Applicant: PRO-MICRON GMBH, Kaufbeuren (DE)

(72) Inventors: Rainer WUNDERLICH, Kaufbeuren (DE); Martin DIX, Chemnitz (DE); Manfred RIETZLER, Bangkok (TH)

(73) Assignee: PRO-MICRON GMBH, Kaufbeuren (DE)

(21) Appl. No.: 17/778,600

(22) PCT Filed: Nov. 9, 2020
(86) PCT No.: PCT/EP2020/081460

§ 371 Date: May 20, 2022

(30) Foreign Application Priority Data
Nov. 21, 2019 (EP) 19210558.3

(51) Int. Cl. G05B 23/02; G06K 9/62

(52) U.S. Cl. CPC G05B 23/0229; G05B 23/0221; G06K 9/6262; G05B 19/4069

(57) ABSTRACT

Method for monitoring and/or predicting machining processes and/or machining outcomes in mechanical workpiece machining carried out by a workpiece processing machine operable by specifiable operating parameters and having at least one machining tool. The monitoring and/or predicting occurs via a computer program product evaluation algorithm executed on a computer on the basis of training data sets. The training data sets include, as training data, adjustment data relating to adjustment of operating parameters of the workpiece processing machine for carrying out a machining process to be monitored and/or predicted. The training data sets further include outcome data of workpieces finished in a machining process to be monitored and/or predicted, and state data of the processing machine, determined by sensor, during a machining process to be monitored and/or predicted. In use, capture of outcome data by prediction made on the basis of machine-learned knowledge is avoided or reduced.

### TECHNICAL FIELD

The invention relates to a method for monitoring and/or predicting machining processes and/or machining outcomes in mechanical workpiece machining carried out by means of a workpiece processing machine operable by specifiable operating parameters and having at least one machining tool. In this context, it relates in particular to those methods which are used in workpiece processing machines for material-removing processing, in particular for metal cutting, such as milling, turning, grinding or drilling.

### BACKGROUND

### Background/Prior Art Description

For the largely automated machining of workpieces, not least for reasons of cost but also for reasons of precision, not only complex and high-precision workpiece processing machines are used today, but increasingly detailed and real-time monitoring is also provided in which, for example, process data of the workpiece machining process are recorded by means of appropriate sensors, collected and made available for evaluation. An example of such a possibility is the sensory tool holder offered on the market by the applicant here under the brand name “SPIKE”, by means of which during a machining process, for example in a milling machine, occurring axial forces as well as transverse forces or bending moments can be recorded. The data obtained in this way can be evaluated by means of evaluation software provided by the present applicant with the sensory tool holder, in particular displayed graphically, in order to draw conclusions about the course of the machining process and/or a state of the tool. However, this evaluation still has to be carried out “manually” by an experienced machine operator. The machine operator can then, in particular in an order made available by the evaluation software of values of the x and y components of recorded bending moments in a coordinate system rotating with the tool holder, for example, detect cutting edge wear on the tool used or a cutting edge breakage, which seriously disrupts quality-oriented production.

While the applicant's sensory tool holder already provides an extremely helpful means of data acquisition in machining processes on workpiece processing machines, the possible evaluation of the parameters determined by sensor (axial forces, bending moment components or shear force components) in order to draw conclusions about the machining process is a good way of observing the process and thus also of guiding the workpiece processing machine, there is nevertheless a need for an even more in-depth analysis of the workpiece machining process, including the possibility of predicting the machining outcome.

### SUMMARY

The present invention is dedicated to this need, which is based on the task of specifying a method for monitoring and/or predicting machining processes and/or machining outcomes in mechanical workpiece machining carried out by means of a workpiece processing machine having at least one machining tool, which allows for more detailed statements about the machining process, the state of the workpiece processing machine and/or the outcome of the machining process, i.e. a defined machining state of the workpiece.

This object is achieved according to the invention by a method for monitoring and/or predicting machining processes and/or machining outcomes in mechanical workpiece machining, in particular material-removing processing, in particular metal cutting, carried out by means of a workpiece processing machine operable by specifiable operating parameters and having at least one machining tool, the monitoring and/or predicting occurring by means of an evaluation algorithm, wherein the evaluation algorithm is obtained by means of a computer program product executed on a computer on the basis of training data sets, wherein the training data sets comprise the following data as training data: adjustment data relating to the adjustment of operating parameters of the workpiece processing machine for carrying out a machining process to be monitored and/or predicted, outcome data of workpieces finished in a machining process to be monitored and/or predicted, as well as state data of the processing machine, determined by sensor, during a machining process to be monitored and/or predicted. Advantageous developments of such a method are that training data sets may be generated and, in a second step, the training data sets and/or the evaluation algorithm obtained on the basis of the training data sets may be transmitted to an evaluation device. The training data at least partially may comprise adjustment data, outcome data and/or state data actually obtained from earlier machining processes which were actually carried out. The evaluation algorithm may be generated on the basis of the training data sets and with recourse to guided learning, in which expert knowledge about machining processes and the behavior of state data, adjustment data and outcome data and their mutual influence may be incorporated into an initial setup of the specifications for the evaluation algorithm. The training data may comprise adjustment data, outcome data, and/or state data obtained, at least in part, from simulated machining processes. The evaluation algorithm may be generated on the basis of the training data sets and using an approximation method, in particular deep learning, convolutional neural network (CNN), recursive nets (RNN, stochastic machine, random forest or support vector machine). The evaluation algorithm may be generated on the basis of the training data sets and with recourse to monitored learning and/or reinforcement learning. The adjustment data may comprise data on the type and/or state of a machining tool of the processing machine, data on the adjusted speeds of workpiece and/or tool spindles of the processing machine, data on an adjusted coolant entry into a machining region and/or data on feed rates of workpiece and/or tool holders. The outcome data may comprise data on the surface condition of the finished workpiece and/or on the dimensional accuracy of the machining outcomes achieved in relation to an outcome specification. The state data may comprise data on the forces and torques acting on the workpiece and/or tool during the machining process, data relating to a motor current consumption by drive motors of the processing machine, temperature data relating to the workpiece, tool and/or further components of the processing machine, data determined on a coolant entry into a machining region, data on a volume and/or shape of the material removed during the machining process and/or data relating to a state of a tool detected during machining. The adjustment data, outcome data, and/or state data determined for a machining process carried out may be used as training data in order to supplement and/or replace the training data sets in order to adapt the evaluation algorithm in this way. The outcomes obtained with the evaluation algorithm in relation to a prediction of the outcome data obtained may be used for monitoring machining outcomes, in particular with regard to quality control. The results obtained with the evaluation algorithm in relation to monitoring the machining process may be used to identify an error in the workpiece processing machine, tool wear and/or tool damage and/or to identify an error in the machining. The evaluation by means of the evaluation algorithm may take place in situ during the machining process. The evaluation may be supplied to a controller of the workpiece processing machine in order to adapt reference variables for the machining process. The evaluation may be carried out by means of the evaluation algorithm after the machining process. The training data sets obtained or adapted during operation of a plurality of workpiece processing machines may be transmitted to a central memory and in that meta-training data records are determined from the individual training data records by linking.

According to the invention, in a method, monitoring and/or predicting machining processes and/or machining outcomes occurs by means of an evaluation algorithm in mechanical workpiece machining carried out by means of a workpiece processing machine operable by specifiable operating parameters and having at least one machining tool, which can in particular involve material-removing processing, in particular metal cutting, such as milling, turning, grinding or drilling. In this case, the evaluation algorithm is obtained by means of a computer program product executed on a computer on the basis of training data sets. According to the invention, the training data sets comprise, as training data, adjustment data relating to the adjustment of operating parameters of the workpiece processing machine for carrying out a machining process to be monitored and/or predicted, outcome data of workpieces finished in a machining process to be monitored and/or predicted, and state data of the processing machine, determined by sensor, during a machining process to be monitored and/or predicted.

The training data in the training data sets are “historical” data that relate to known, already performed or simulated machining processes and based on which the evaluation algorithm is created by means of the computer program product executed on the computer. The creation of the evaluation algorithm is typically based on a plurality of training data and training data sets, with the processing in the computer program product using methods and models of so-called artificial intelligence. This means that the computer program product executed on the computer designs and improves or refines the evaluation algorithm based on a procedure specified for the computer program product in an independent process, in particular by so-called machine learning.

Such a procedure makes it possible to monitor the process more precisely or to make a more accurate prediction of the machining outcome on the basis of a plurality of data collected about the specific machining process, or to detect deviations and errors in the workpiece processing machine and/or in the machining. Such a procedure allows, for example, due to the amount and width of data and the evaluation algorithm, a very good prediction of dimensions of the finished workpiece with a machining process that has been carried out and observed in the monitored parameters, its quality and compliance with the machining specifications. In particular, based on such predictions, an accurate quality protocol for the machined workpiece can be created and assigned to the workpiece, which can replace a subsequent check and measurement of the workpiece as part of a quality control process and make such a check superfluous. In this way, time and costly resources can be saved without the checking and monitoring of the required quality being impaired or even omitted.

The method can also be used to detect possible errors in the workpiece processing machine or in the machining process, such as worn bearings of the workpiece or tool spindle, imbalances that occur, a worn or even broken tool or insufficient clamping of the workpiece or incorrect tool mounting. Similarly, when setting up a machining process, by selecting and specifying the characteristic values of the operating parameters of the workpiece processing machine to be adjusted, such adjustments can be determined that allow machining that is gentle on the machine and workpiece, precise and at the same time as fast as possible in terms of throughput.

For the creation of the evaluation algorithm, certain operations and links are first specified in the computer program product and a plurality, in particular a large number of training data sets are generated, which are then processed in the computer program product executed on the computer, in accordance with specified models for an improvement and further adjustment of the evaluation algorithm, allowing a prediction of, for example, the outcome data from the data obtained and determined, for example on the basis of adjustment data and state data. The training data can be data determined in machining processes that are actually carried out or taken from the workpieces obtained in these machining processes by measuring. However, they can also be data obtained from simulations of machining processes. The more training data sets are used as a basis, with in particular different parameter settings and different processing sequences, for example also with errors in the processing machine, in the processing process and the like, the more exact the evaluation algorithm created by the computer program product executed on the computer will be and the more precisely it can be used to make predictions and monitor the machining process.

The methods and models that are stored in the computer program product as a framework for generating the evaluation algorithm on the basis of the training data sets can be generated using an empirical or analytical method and procedure. Typically, generalizations of certain relationships that have been recognized as relevant to the behavior of the workpiece processing machine and/or the work outcome obtained in the observed machining process are taken into account here, and basic operating instructions are created on this basis. The processing of the training data and training data sets in the computer program product executed on the computer can then be carried out by means of an approximation method, in particular deep learning, convolutional neural network (CNN), recursive nets (RNN), stochastic machine, random forest or support vector machine, to generate the evaluation algorithm. These approximation methods relate to various optimization methods for artificial neural networks, which have a number of intermediate layers between an input layer and an output layer and whose internal structure can be formed as part of training by means of the training data from the training data sets.

In this case, in particular, monitored learning and/or reinforcement learning can be used. The computer program product or the software of the computer can then use the training data and training data sets to identify their categories and relationships. A clustering method can be used in supervised learning.

Guided learning can be used with particular advantage, in which expert knowledge about machining processes and the behavior of state data, adjustment data and outcome data and their mutual influence is incorporated into an output device of the specifications for the evaluation algorithm. In this way, learning does not take place blindly, but is guided on the basis of previous knowledge. If, for example, a measuring device is used to record forces and moments occurring during machining, as is offered on the market by the applicant under the brand name SPIKE®, existing knowledge about measurement data recorded with these measuring devices and relationships derived therefrom can be incorporated into the learning requirements for improving the evaluation algorithm, e.g. knowledge that an asymmetrical distribution of the cutting forces per cutting edge in a symmetrically formed tool allows a conclusion to be drawn about tool wear. Corresponding knowledge can be gained, for example, using methods as described in EP 2 829 259 A1, EP 2 924 526 A1 or EP 3 486 737 A1.

When entering the existing expert knowledge, a preliminary evaluation, data filtering and data structuring takes place in order to prepare the data for the further learning process and to make the information embedded therein available for the machine learning process. In this context, a conscious distinction is made between adjustment data (read out or input), i.e. data on the adjustment of the processing machine for the machining process, state data obtained during the process and outcome data obtained after the process.

Appropriate knowledge about, for example, the importance of such symmetry considerations is thus entered into the system as input variables in order to allow faster and more targeted guided learning. This also has the decisive advantage that far fewer training data sets are required, since the system does not have to relearn knowledge that was already known and that was incorporated into the basic setup. Especially in the case of material-removing processing, in particular metal cutting, free learning without the provision of such expert knowledge would not lead to any meaningful outcome, since the amount of relevant data to be assigned is simply limited and the system with free learning hardly has enough usable information about relevant contexts.

Adjustment data can comprise, in particular, data on the type and/or state of a machining tool of the processing machine used before the machining process and used to carry out the machining process, data on an adjusted speed of the workpiece and/or tool spindle of the processing machine, data on an adjusted coolant entry into a machining region of the workpiece processing machine and/or data on feed rates of workpiece and/or tool holders or the like. In principle, all data that determine or condition the adjustment of the workpiece processing machine for operation during the machining process can be taken into account as adjustment data. To determine the evaluation algorithm, the relevance of individual adjustment data can be weighted in the computer program product executed on the computer.

Outcome data can comprise, for example, data on the surface quality of the finished workpiece and/or on the dimensional accuracy of the machining outcomes achieved in relation to an outcome specification, in particular the tolerance accuracy. Here, too, all data relevant to the assessment of the machining outcome can be used as outcome data as part of the training data and the training data sets formed therewith. Outcome data are primarily considered for the creation of training data sets, they are typically not, at least not continuously, collected and used as a basis during operation and for the implementation of the monitoring, since one aim of the method according to the invention is precisely to use the outcomes of the machining of the workpiece with the workpiece processing machine, i.e. ultimately to reliably predict the outcome data. Of course, in the course of a check, the outcome data of a machining process monitored with the method can also be determined in order to verify the correctness of the prediction made and, if necessary, to obtain a further improvement of the evaluation algorithm with new training data sets.

State data can in particular comprise data on the forces and torques acting on the workpiece and/or tool during the machining process, data relating to a motor current consumption by drive motors of the processing machine, for example drive motors for the rotation of tool or workpiece spindles, data for drive motors for the feed rate of the tool and/or workpiece, temperature data relating to the workpiece, tool and/or further components of the processing machine, data determined on a coolant entry into a machining region, data on a volume and/or shape of the material removed during the machining process and/or data relating to a state of a tool detected during machining. Insofar as data on the forces and/or moments acting on the workpiece and/or tool during the machining process are recorded, these can also be recorded divided according to spatial components in a reference coordinate system, e.g. in a coordinate system that is stationary with respect to the workpiece or the tool, in which case a temporal relationship between these components will also be included, as is described, for example, in EP 2 924 526 A1. Different and suitable sensors can be used to determine such state data, for example a tool holder equipped with sensors, such as the applicant offers and sells under the brand name “SPIKE”, workpiece holders equipped with sensors, measuring devices for motor current and the like. Again, the more diverse the data acquisition, the more phenomena can be identified, and the more precisely the evaluation algorithm can be designed from the training data sets by means of machine learning using the principle of artificial intelligence.

The evaluation can be carried out in situ during the machining process in order to obtain real-time process monitoring. In such a case, in particular if problems with the process control, errors in the machining process or faults and errors in the region of the workpiece processing machine are detected, an intervention can be made by a controller of the workpiece processing machine if the results of the evaluation are fed thereto and this controller, based on the outcomes and according to specifications on the basis of the evaluation and prediction from the training data sets, adjusts the reference variables for the machining process accordingly, i.e. makes adjustment changes for the adjustment parameters of the workpiece processing machine in order to regulate the workpiece machining process. If necessary, if a serious error is detected, the processing machine can also be stopped automatically, and if intervention by the machine operator is required, an error message or even an alarm can be given. If an evaluation in real time is not possible, a very timely evaluation can also be advantageous, since this also allows a possible intervention in the process.

It is also possible to promptly generate an output signal if a problem or an irregularity has been detected by the evaluation algorithm during the machining of a workpiece, in order to separate out the workpiece and subject it to a separate check or to discard it as an exclusion.

However, it is also conceivable for the evaluation to be carried out by means of the evaluation algorithm in a separate method step after the machining process. In particular, this also allows data that cannot be determined in situ to be taken into account, for example the volume and/or shape of removed material, for example chip material in a milling process or in a drilling process. If such data are to be included in order to create an exact outcome protocol with regard to the outcome data of the machined workpiece, such a procedure is advisable. Combinations can also be made here, i.e. an evaluation in situ, e.g. with the aim of process monitoring, and an evaluation after the machining for a comprehensive assessment of the work outcome, in particular from the point of view of quality monitoring.

In particular, the method according to the invention can also be expanded in an application for not just one workpiece processing machine operated in isolation, but for a plurality of such machines. Correspondingly, training data sets can be recorded by a plurality of workpiece processing machines and transmitted to a central memory, for example in a cloud, and meta-training data sets can be determined from the individual training data sets by linking them. These meta-training data sets can in turn be supplied to a meta-data evaluation algorithm for a comparative evaluation of a pool of processing machines or of machining processes carried out thereon. Such a procedure allows, for example, a detection of deviations in the respective operation of different workpiece processing machines and the resulting outcomes and thus in turn allows an even more precise optimization of the evaluation algorithms on the basis of such training data sets and meta-training data sets.

It is also possible to use the results of the prediction made of a first machining outcome as input information (command variable) for a subsequent machining process. In other words, a machining outcome predicted by the method described above for a first machining process, such as a surface quality of a workpiece machined in the first machining process, can be used for a subsequent machining process as an input variable for its control or parameter adjustment. For example, the predicted roughness of a surface of the workpiece after a roughing process can be used to control stock removal or other process parameters of a subsequent finishing process. This makes it possible to increase the machining speed and/or machining accuracy in subsequent machining processes, which can also be referred to as machining steps here, because it is possible, without a measurement otherwise required for this, to include information about an intermediate state of the workpiece after the first machining process for further machining and to adapt the subsequent machining process accordingly to this data and information regarding the initial state.

### BRIEF DESCRIPTION OF THE SEVERAL VIEWS OF THE DRAWINGS

The method according to the invention and the associated procedure are explained in more detail below with reference to the accompanying drawings. In the drawings:

FIG. 1 is, in the form of a diagram, an illustration of the learning process for obtaining the evaluation algorithm on the basis of training data sets and using artificial intelligence (AI), and

FIG. 2 is, in the form of a diagram, an illustration of the use of the evaluation algorithm obtained by means of the learning process for predicting machining outcomes.

### DESCRIPTION

The drawings show the procedure according to the method according to the invention and the use of the evaluation algorithm obtained by means of a machine learning process on the basis of the use of artificial intelligence (AI) for predicting machining outcomes in mechanical workpiece machining carried out by means of a workpiece processing machine, in particular material-removing processing, preferably metal cutting, illustrated by examples.

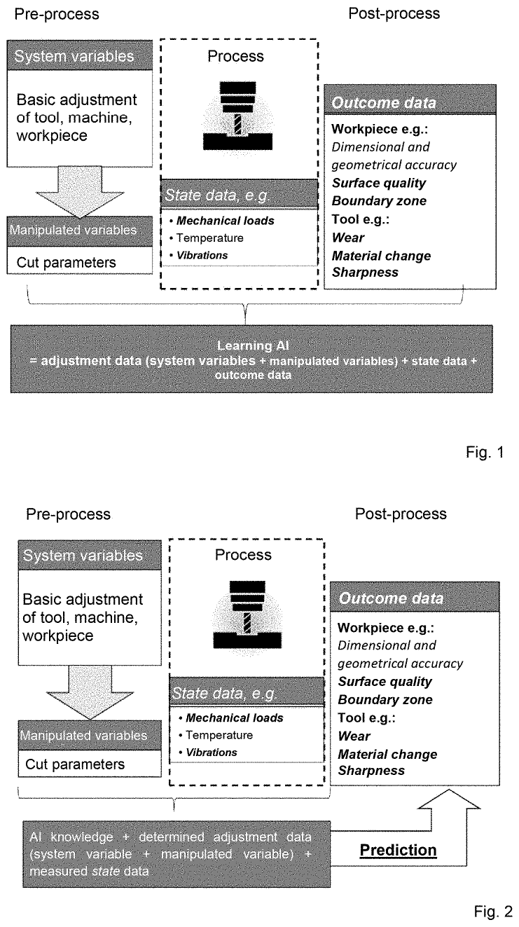

Firstly, as shown in FIG. 1, machine learning and the creation of an evaluation algorithm are carried out as part of a training phase. This is carried out using a computer program product executed on a computer. The computer program product is given correlated data as training data sets consisting of adjustment data; these are the basic adjustments of the processing machine (also called system variables here) and data relating to the adjustments of the processing machine in the process (also called manipulated variables here), state data; these are data recorded during the process flow and relating to the process flow, such as recorded mechanical loads, such as the forces and moments acting on the tool and/or workpiece, for example, a temperature of the tool and/or workpiece, recorded vibrations or the like, and outcome data; these are, for example, data on the machining outcome on the workpiece, such as data on the dimensional and geometrical accuracy or surface quality, as well as data on a state of the tool after the process, such as wear, cutting edge sharpness and the like. The training data sets comprise such adjustment data, state data and outcome data pertaining to a machining process that has been carried out. These training data sets are evaluated using AI and form the basis of machine learning, which ultimately forms and refines an evaluation algorithm for predicting and/or evaluating machining outcomes. In the process, the system for machine learning is also given further specifications from existing expert knowledge, which takes into account already known relationships between values of individual training data or tendencies in the training data. This is how guided learning takes place.

The training data and training data sets entered in this learning phase can be obtained from machining processes actually carried out or obtained by means of simulation.

After completion of the learning phase run through by means of AI, e.g. after training using training data sets for 100 different machining processes, the evaluation algorithm obtained in this way can then be used as knowledge, so-called AI knowledge, in order to make a prediction of the outcome data. This is shown in FIG. 2.

1. A method for monitoring or predicting machining processes or machining outcomes in mechanical workpiece machining carried out by means of a workpiece processing machine operable by specifiable operating parameters and having at least one machining tool, the monitoring or predicting occurring by means of an evaluation algorithm;
wherein the evaluation algorithm is obtained by means of a computer program product executed on a computer on the basis of training data sets;
wherein the training data sets comprise the following data as training data:
adjustment data relating to the adjustment of operating parameters of the workpiece processing machine for carrying out a machining process to be monitored or predicted;
outcome data of workpieces finished in the machining process to be monitored or predicted; and
state data of the processing machine, determined by sensor, during the machining process to be monitored or predicted.

2. The method according to claim 1, wherein in a first step, training data sets are generated and, in a second step, the training data sets or the evaluation algorithm obtained on the basis of the training data sets are transmitted to an evaluation device.

3. The method according to claim 1, wherein the training data at least partially comprise adjustment data, outcome data or state data actually obtained from earlier machining processes which were actually carried out.

4. The method according to claim 1, wherein the evaluation algorithm is generated on the basis of the training data sets and with recourse to guided learning, in which expert knowledge about machining processes and the behavior of state data, adjustment data and outcome data and their mutual influence is incorporated into an initial setup of the specifications for the evaluation algorithm.

5. The method according to claim 1, wherein the training data comprise adjustment data, outcome data or state data obtained, at least in part, from simulated machining processes.

6. The method according to claim 1, wherein the evaluation algorithm is generated on the basis of the training data sets and using an approximation method.

7. The method according to claim 1, wherein the evaluation algorithm is generated on the basis of the training data sets and with recourse to monitored learning or reinforcement learning.

8. The method according to claim 1, wherein the adjustment data comprise data on the type or state of the machining tool of the processing machine, data on the adjusted speeds of workpiece or tool spindles of the processing machine, data on an adjusted coolant entry into a machining region or data on feed rates of workpiece or tool holders.

9. The method according to claim 1, wherein the outcome data comprise data on a surface condition of the finished workpiece or on dimensional accuracy of the machining outcomes achieved in relation to an outcome specification.

10. The method according to claim 1, wherein the state data comprise data on the forces and torques acting on the workpiece or tool during the machining process, data relating to a motor current consumption by drive motors of the processing machine, temperature data relating to the workpiece, tool or further components of the processing machine, data determined on a coolant entry into a machining region, data on a volume or shape of the material removed during the machining process or data relating to a state of a tool detected during machining.

11. The method according to claim 1, wherein the adjustment data, outcome data or state data determined for the machining process carried out are used as training data in order to supplement or replace the training data sets in order to adapt the evaluation algorithm.

12. The method according to claim 1, wherein the outcomes obtained with the evaluation algorithm in relation to a prediction of the outcome data obtained are used for monitoring machining outcomes, with regard to quality control.

13. The method according to claim 1, wherein the results obtained with the evaluation algorithm in relation to monitoring the machining process are used to identify an error in the workpiece processing machine, tool wear or tool damage or to identify an error in the machining.

14. The method according to claim 1, wherein the evaluation by means of the evaluation algorithm takes place in situ during the machining process.

15. The method according to claim 14, wherein the results of the evaluation are supplied to a controller of the workpiece processing machine in order to adapt reference variables for the machining process.

16. The method according to claim 1, wherein the evaluation is carried out by means of the evaluation algorithm after the machining process.

17. The method according to claim 1, wherein training data sets obtained or adapted during operation of a plurality of workpiece processing machines are transmitted to a central memory and in that meta-training data records are determined from the individual training data records by linking.

18. The method according to claim 17, wherein the meta-training data sets are supplied to a meta-data evaluation algorithm for a comparative evaluation.

19. Use of predictions obtained by means of a method according to claim 1 about a machining outcome of a first machining process as an input variable for a subsequent machining process to be carried out on a workpiece machined in the first machining process.

20. The method according to claim 6, wherein the approximation method comprises one or more of deep learning, convolutional neural network (CNN), recursive nets (RNN), stochastic machine, random forest or a support vector machine.
